(19) United States
(12) Patent Application Publication
(10) Pub. No.: US 2018/0148563 A1
(43) Pub. Date: May 31, 2018

(54) CARBON MATERIAL PRECURSOR AND METHOD FOR PRODUCING CARBON MATERIAL USING THE SAME

(71) Applicant: KABUSHIKI KAISHA TOYOTA CHUO KENKYUSHO, Nagakute-shi (JP)

(72) Inventors: Kenichi HAYASHIDA, Nagakute-shi (JP); Takuya MORISHITA, Nagakute-shi (JP)

(73) Assignee: KABUSHIKI KAISHA TOYOTA CHUO KENKYUSHO, Nagakute-shi (JP)

(21) Appl. No.: 15/822,575

(22) Filed: Nov. 27, 2017

(30) Foreign Application Priority Data
Nov. 28, 2016 (JP) 2016-230452

(51) Int. Cl. C08K 3/38; C01B 32/05; C08F 120/56; C08K 3/32; C08K 3/30; C08K 3/28; C08K 3/26; C08K 5/092

(52) U.S. Cl. CPC C08K 3/38; C01B 32/05; C08F 120/56; C08K 3/32; C08K 3/30; C08K 3/28; C08K 2003/262; C08K 5/092; C08K 2003/329; C08K 2003/322; C08K 2003/324; C08K 2003/3054; C08K 2003/3045; C08K 3/26

(57) ABSTRACT

A carbon material precursor comprises an acrylamide-based polymer and at least one addition component selected from the group consisting of acids and salts thereof; and a method for producing a carbon material comprises thermally-stabilizing the carbon material precursor and then carbonizing the carbon material precursor.

### BACKGROUND OF THE INVENTION

### Field of the Invention

The present invention relates to a carbon material precursor and a method for producing a carbon material using the same.

### Related Background Art

Heretofore, as a method for producing carbon fibers, which are a type of carbon material, a method including: thermally-stabilizing a carbon fiber precursor obtained by spinning polyacrylonitrile; and then carbonizing the carbon fiber precursor has been mainly employed (for example, Japanese Examined Patent Application Publication No. Sho 37-4405 (Patent Literature 1), and Japanese Unexamined Patent Application Publication Nos. 2015-74844 (Patent Literature 2), 2016-40419 (Patent Literature 3), and 2016-113726 (Patent Literature 4)). There has been a problem that the producing cost of carbon fibers is high because polyacrylonitrile used in this method is poorly soluble in inexpensive general-purpose solvents and hence it is necessary to use expensive solvents such as dimethyl sulfoxide and N,N-dimethylacetamide for polymerization and spinning.

Meanwhile, polyacrylamide, which is a water-soluble polymer, is expected to reduce the producing cost of carbon material because water, which is inexpensive and has a low environmental load, can be used as a solvent for polymerization and spinning.

### SUMMARY OF THE INVENTION

However, there has been a problem that a carbon material precursor prepared using polyacrylamide has a low carbonization yield because the mass of such carbon material precursor decreases to only about 20% when heated to 500° C.

The present invention has been made in view of the above-mentioned problem of the related art and an object thereof is to provide a carbon material precursor which contains an acrylamide-based polymer and has a high carbonization yield, and a method for producing a carbon material using the same.

The present inventors have made earnest studies to achieve the object described above and as a result found that the carbonization yield of a carbon material precursor containing an acrylamide-based polymer is improved by adding to the acrylamide-based polymer at least one addition component selected from the group consisting of acids and salts thereof, which led to the completion of the present invention.

Specifically, a carbon material precursor of the present invention comprises: an acrylamide-based polymer; and at least one addition component selected from the group consisting of acids and salts thereof. In such a carbon material precursor of the present invention, the addition component is preferably at least one selected from the group consisting of phosphoric acid, polyphosphoric acid, boric acid, sulfuric acid, nitric acid, carbonic acid, oxalic acid, citric acid, sulfonic acid, and salts thereof. Meanwhile, the addition component is preferably at least one selected from the group consisting of ammonium salts and amine salts. The addition component is further preferably at least one selected from the group consisting of phosphoric acid, polyphosphoric acid, boric acid, sulfuric acid, nitric acid, carbonic acid, oxalic acid, citric acid, sulfonic acid, and salts thereof, as well as at least one selected from the group consisting of ammonium salts and amine salts. Furthermore, a content of the addition component is preferably 0.1 to 20% by mass relative to 100% by mass of the carbon material precursor.

A method for producing a carbon material of the present invention comprises: thermally-stabilizing such a carbon material precursor of the present invention; and then carbonizing the carbon material precursor. In the thermal-stabilization, the carbon material precursor is preferably heated under an oxidizing atmosphere at a temperature of 500° C. or lower. In the carbonization, the thermally-stabilized carbon material precursor is preferably heated under an inert atmosphere at a temperature higher than the heating temperature during the thermal-stabilization.

Note that it is not necessarily certain why the carbon material precursor of the present invention has a high carbonization yield. The present inventors have surmised as follows. Specifically, it is presumed that by heating (in particular, thermally-stabilizing) the carbon material precursor of the present invention, an acid or a salt thereof which is the addition component functions as a catalyst for the dehydration reaction of the acrylamide-based polymer and the structure of the acrylamide-based polymer transforms to a highly heat-resistant structure, enhancing the carbonization yield of the carbon material precursor.

The present invention makes it possible to obtain a carbon material precursor which contains an acrylamide-based polymer and has a high carbonization yield. In addition, use of such a carbon material precursor of the present invention makes it possible to safely produce a carbon material at a low cost.

### BRIEF DESCRIPTION OF THE DRAWINGS

FIG. 1 is a graph illustrating the relationship between the carbonization yields and the contents of the addition components in the carbon material precursors obtained in Examples 1 and 2, Examples 21 to 26, and Comparative Example 1.

### DETAILED DESCRIPTION OF THE PREFERRED EMBODIMENTS

Hereinafter, the present invention is described in detail based on its preferred embodiments.

First, a carbon material precursor of the present invention is described. The carbon material precursor of the present invention contains an acrylamide-based polymer and at least one addition component selected from the group consisting of acids and salts thereof. Addition of the addition component to the acrylamide-based polymer improves the carbonization yield of the carbon material precursor.

(Acrylamide-Based Polymer)

The acrylamide-based polymer used in the present invention is soluble in at least one of an aqueous solvent (e.g. water, alcohol, or a mixture solvent thereof) and a water-based mixture solvent (mixture solvent of the above-described aqueous solvent and an organic solvent (e.g. tetrahydrofuran)). This makes it possible to perform wet blending using the aqueous solvent or the water-based mixture solvent described above in the production of a carbon material precursor and to safely blend the acrylamide-based polymer and the addition component homogeneously at a low cost. In addition, in the forming of the obtained carbon material precursor, dry forming (dry spinning) or wet forming (wet spinning (including electrospinning)) can be performed using the aqueous solvent or the water-based mixture solvent described above, making it possible to safely produce a carbon material at a low cost. Here, the content of an organic solvent in the water-based mixture solvent is not particularly limited as long as the organic solvent blended makes it possible for the acrylamide-based polymer to solve in the aqueous solvent which would otherwise be insoluble or poorly soluble in the aqueous solvent. Moreover, such an acrylamide-based polymer is preferably an acrylamide-based polymer which is soluble in the aqueous solvent, and more preferably an acrylamide-based polymer which is soluble in water (a water-soluble acrylamide-based polymer), from the viewpoint that a carbon material precursor and a carbon material can be safely produced at a lower cost.

Such an acrylamide-based polymer may be any of a homopolymer of acrylamide-based monomer and a copolymer of acrylamide-based monomer and a different polymerizable monomer as long as the acrylamide-based polymer is soluble in at least one of the aqueous solvent and the water-based mixture solvent. Nonetheless, the acrylamide-based polymer is preferably a polymer containing 50 mol % or more of acrylamide-based monomer unit, more preferably a polymer containing 70 mol % or more of acrylamide-based monomer unit, still more preferably a polymer containing 90 mol % or more of acrylamide-based monomer unit, and particularly preferably a homopolymer of acrylamide-based monomer, from the viewpoint that the acrylamide-based polymer easily solves in at least one of the aqueous solvent and the water-based mixture solvent (preferably the aqueous solvent and more preferably water).

Examples of the acrylamide-based monomer include acrylamide, methacrylamide, N-methylacrylamide, N-methylmethacrylamide, N-(hydroxymethyl)acrylamide, N-(hydroxymethyl)methacrylamide, N-(2-hydroxyethyl)acrylamide, N-(2-hydroxyethyl)methacrylamide, N,N-dimethylacrylamide, and N,N-dimethylmethacrylamide. Such an acrylamide-based monomer may be used singly or in combination of two or more kinds. Moreover, acrylamide is preferable among these acrylamide-based monomers from the viewpoint that acrylamide is excellent in water solubility.

Examples of the different polymerizable monomer described above include a vinyl cyanide-based monomer such as acrylonitrile and methacrylonitrile, a (meth)acrylic acid ester such as methyl acrylate and methyl methacrylate, an unsaturated carboxylic acid such as acrylic acid, methacrylic acid and itaconic acid, as well as salts thereof, an unsaturated carboxylic acid anhydride such as maleic anhydride and itaconic acid anhydride, an aromatic vinyl-based monomer such as styrene and a-methylstyrene, a vinyl-based monomer such as vinyl chloride and vinyl alcohol; and an olefin-based monomer such as ethylene and propylene. The different polymerizable monomer mentioned above may be used singly or in combination of two or more kinds. Moreover, acrylonitrile is preferable among these polymerizable monomers from the viewpoint that the carbonization yield of a carbon material precursor is enhanced.

Known polymerization methods such as solution polymerization and suspension polymerization can be employed as a method for producing such an acrylamide-based polymer. When the solution polymerization is employed, the solvent is not particularly limited as long as the solvent dissolves the raw material monomer and the obtained acrylamide-based polymer. Nonetheless, the aqueous solvent (e.g. water, alcohol, or a mixture solvent thereof) or the water-based mixture solvent (mixture solvent of the above-described aqueous solvent and an organic solvent (e.g. tetrahydrofuran)) is preferably used, the aqueous solvent is more preferably used, and water is particularly preferably used, from the viewpoint that the production can be safely performed at a low cost. Furthermore, polymerization initiators include a radical polymerization initiator which is soluble in at least one of the aqueous solvent and the water-based mixture solvent such as 4,4′-azobis(4-cyanovaleric acid), ammonium persulfate, and potassium persulfate (preferably the aqueous solvent and more preferably water).

(Addition Component)

The addition component used in the present invention is at least one selected from the group consisting of acids and salts thereof and is a component which is soluble in at least one of the aqueous solvent and the water-based mixture solvent (preferably the aqueous solvent and more preferably water). This makes it possible to perform wet blending using the aqueous solvent or the water-based mixture solvent described above in the production of a carbon material precursor and to safely blend the acrylamide-based polymer and the addition component homogeneously at a low cost. In addition, in the forming of the obtained carbon material precursor, dry forming (dry spinning) or wet forming (wet spinning (including electrospinning)) can be performed using the aqueous solvent or the water-based mixture solvent described above, making it possible to safely produce a carbon material at a low cost.

Examples of the acid include an inorganic acid such as phosphoric acid, polyphosphoric acid, boric acid, sulfuric acid, nitric acid, and carbonic acid, and an organic acid such as oxalic acid, citric acid, and sulfonic acid. In addition, the salts of such an acid include a metal salt (e.g. a sodium salt and a potassium salt), an ammonium salt, and an amine salt, an ammonium salt and an amine salt are preferable, and an ammonium salt is more preferable. In particular, among these addition components, phosphoric acid, polyphosphoric acid, boric acid, sulfuric acid, and ammonium salts thereof are preferable, phosphoric acid, polyphosphoric acid, boric acid, and ammonium salts thereof are more preferable, and phosphoric acid, polyphosphoric acid, an ammonium salt of phosphoric acid, and an ammonium salt of polyphosphoric acid are particularly preferable, from the viewpoint that the carbonization yield of the obtained carbon material precursor is further improved.

### <Carbon Material Precursor>

The carbon material precursor of the present invention contains the acrylamide-based polymer and the addition component. The content of the acrylamide-based polymer and the content of the addition component are not particularly limited in such a carbon material precursor. Nonetheless, the content of the acrylamide-based polymer is preferably 80 to 99.9% by mass and the content of the addition component is preferably 0.1 to 20% by mass, and the content of the acrylamide-based polymer is more preferably 85 to 99.7% by mass and the content of the addition component is more preferably 0.3 to 15% by mass, relative to 100% by mass of the carbon material precursor, from the viewpoint that the carbonization yield of the carbon material precursor is further improved. If the content of the addition component is below the lower limit, the carbonization yield of the carbon material precursor tends not to be improved. If the content of the addition component exceeds the lower limit, the addition effect by the addition component tends not to be sufficiently obtained.

Such a carbon material precursor of the present invention can be produced by directly blending (melt blending) the addition component in the melted acrylamide-based polymer or by dry blending the acrylamide-based polymer and the addition component. Since the acrylamide-based polymer and the addition component to be used are soluble in at least one of the aqueous solvent and the water-based mixture solvent (preferably the aqueous solvent and more preferably water), the carbon material precursor is preferably produced by dissolving (wet blending) the acrylamide-based polymer and the addition component in the aqueous solvent or the water-based mixture solvent and then removing the solvent from the obtained solution. This makes it possible to safely blend the acrylamide-based polymer and the addition component homogeneously at a low cost. Moreover, in the wet blending, the aqueous solvent is more preferably used as the solvent, and water is particularly preferably used as the solvent, from the viewpoint that the carbon material precursor can be produced at a lower cost. Furthermore, the method for removing the solvent is not particularly limited. A known drying method such as hot air drying, vacuum drying, or freeze drying can be employed. Hot air drying is preferable among these methods in view of its simple equipment.

### <Method for Producing Carbon Material>

The method for producing the carbon material of the present invention includes thermally-stabilizing (flameproofing) such a carbon material precursor of the present invention and then carbonizing the carbon material precursor.

In the method for producing the carbon material of the present invention, first, the carbon material precursor of the present invention is heated under an oxidizing atmosphere (for example, in the air) (thermal-stabilization). This improves the heat resistance of the carbon material precursor because the structure of the acrylamide-based polymer in the carbon material precursor is changed by acting of the acid or the salt thereof in the carbon material precursor. The heating temperature during such thermal-stabilization is preferably 500° C. or less and more preferably 150 to 300° C. Besides, the heating time during the thermal-stabilization is not particularly limited, and the heating exceeding 1 hour can also be performed. Nonetheless, the heating time is preferably 1 to 60 minutes.

Next, the carbon material precursor thermally-stabilized as described above (thermally-stabilized carbon material precursor) is heated under an inert atmosphere (in an inert gas such as nitrogen, argon, or helium) at a temperature higher than the heating temperature in the thermal-stabilization (carbonization). This carbonizes the acrylamide-based polymer in the thermally-stabilized carbon material precursor to obtain the desired carbon material. The heating temperature during the carbonization described above is preferably 500° C. or more and more preferably 1000° C. or more. In addition, the upper limit of the heating temperature is preferably 3000° C. or less and more preferably 2000° C. or less. Moreover, although the heating time during the carbonization is not particularly limited. Nonetheless, the heating time is preferably 1 to 60 minutes and more preferably 1 to 30 minutes.

Furthermore, in the method for producing the carbon material of the present invention, it is preferable to form (spin) in advance the carbon material precursor to be used into a desired shape (for example, fibrous shape) prior to the thermal-stabilization. Here, melt forming (melt spinning) using a melted carbon material precursor may be performed. However, since the acrylamide-based polymer and the addition component contained in the carbon material precursor of the present invention are soluble in at least one of the aqueous solvent and the water-based mixture solvent (preferably the aqueous solvent and more preferably water), it is preferable to dissolve the carbon material precursor in the aqueous solvent or the water-based mixture solvent and then to perform dry forming (dry spinning), dry-wet forming (dry-wet spinning (dry-jet-wet spinning)), wet forming (wet spinning), or electrospinning using the obtained solution. This makes it possible to safely produce the carbon material precursor in the desired shape at a low cost. Moreover, as the solvent, the aqueous solvent is preferably used and water is particularly preferably used from the viewpoint that the carbon material can be safely produced at a lower cost.

### EXAMPLES

Hereinafter, the present invention is described in further detail based on Examples and Comparative Example. However, the present invention is not limited to Examples to be described later.

### Synthetic Example 1

Dissolved into 190 ml of water was 8.52 g (120 mmol) of acrylamide (manufactured by Wako Pure Chemical Industries, Ltd. and for electrophoresis). After that, 366 mg (1.20 mmol) of 4,4′-azobis(4-cyanovaleric acid) was added as a polymerization initiator, followed by radical polymerization for 3 hours at 70° C. The obtained aqueous solution was introduced into methanol, followed by precipitation of polyacrylamide. Polyacrylamide was collected and subjected to vacuum drying.

### Example 1

Polyacrylamide obtained in Synthetic Example 1 was dissolved into water so as to be a concentration of 10% by mass. Phosphoric acid was added to the obtained polyacrylamide aqueous solution so that the content of phosphoric acid was 2% by mass relative to 100% by mass of carbon material precursor. Freeze drying was performed using the obtained phosphoric acid-containing polyacrylamide aqueous solution. As a result, a carbon material precursor containing polyacrylamide and phosphoric acid was obtained.

### Example 2

A carbon material precursor was obtained in the same manner as that in Example 1 except that diammonium hydrogen phosphate was used instead of the phosphoric acid. Note that the content of diammonium hydrogen phosphate was 2% by mass relative to 100% by mass of carbon material precursor.

### Example 3

A carbon material precursor was obtained in the same manner as that in Example 1 except that ammonium dihydrogen phosphate was used instead of the phosphoric acid. Note that the content of ammonium dihydrogen phosphate was 2% by mass relative to 100% by mass of carbon material precursor.

### Example 4

A carbon material precursor was obtained in the same manner as that in Example 1 except that polyphosphoric acid was used instead of the phosphoric acid. Note that the content of polyphosphoric acid was 2% by mass relative to 100% by mass of carbon material precursor.

### Example 5

A carbon material precursor was obtained in the same manner as that in Example 1 except that trisodium phosphate was used instead of the phosphoric acid. Note that the content of trisodium phosphate was 2% by mass relative to 100% by mass of carbon material precursor.

### Example 6

A carbon material precursor was obtained in the same manner as that in Example 1 except that sodium hydrogen phosphate was used instead of the phosphoric acid. Note that the content of sodium hydrogen phosphate was 2% by mass relative to 100% by mass of carbon material precursor.

### Example 7

A carbon material precursor was obtained in the same manner as that in Example 1 except that sodium dihydrogen phosphate was used instead of the phosphoric acid. Note that the content of sodium dihydrogen phosphate was 2% by mass relative to 100% by mass of carbon material precursor.

### Example 8

A carbon material precursor was obtained in the same manner as that in Example 1 except that tripotassium phosphate was used instead of the phosphoric acid. Note that the content of tripotassium phosphate was 2% by mass relative to 100% by mass of carbon material precursor.

### Example 9

A carbon material precursor was obtained in the same manner as that in Example 1 except that dipotassium hydrogen phosphate was used instead of the phosphoric acid. Note that the content of dipotassium hydrogen phosphate was 2% by mass relative to 100% by mass of carbon material precursor.

### Example 10

A carbon material precursor was obtained in the same manner as that in Example 1 except that potassium dihydrogen phosphate was used instead of the phosphoric acid. Note that the content of potassium dihydrogen phosphate was 2% by mass relative to 100% by mass of carbon material precursor.

### Example 11

A carbon material precursor was obtained in the same manner as that in Example 1 except that boric acid was used instead of the phosphoric acid. Note that the content of boric acid was 2% by mass relative to 100% by mass of carbon material precursor.

### Example 12

A carbon material precursor was obtained in the same manner as that in Example 1 except that ammonium sulfate was used instead of the phosphoric acid. Note that the content of ammonium sulfate was 2% by mass relative to 100% by mass of carbon material precursor.

### Example 13

A carbon material precursor was obtained in the same manner as that in Example 1 except that ammonium hydrogen sulfate was used instead of the phosphoric acid. Note that the content of ammonium hydrogen sulfate was 2% by mass relative to 100% by mass of carbon material precursor.

### Example 14

A carbon material precursor was obtained in the same manner as that in Example 1 except that sodium sulfate was used instead of the phosphoric acid. Note that the content of sodium sulfate was 2% by mass relative to 100% by mass of carbon material precursor.

### Example 15

A carbon material precursor was obtained in the same manner as that in Example 1 except that sodium hydrogen sulfate was used instead of the phosphoric acid. Note that the content of sodium hydrogen sulfate was 2% by mass relative to 100% by mass of carbon material precursor.

### Example 16

A carbon material precursor was obtained in the same manner as that in Example 1 except that sodium nitrate was used instead of the phosphoric acid. Note that the content of sodium nitrate was 2% by mass relative to 100% by mass of carbon material precursor.

### Example 17

A carbon material precursor was obtained in the same manner as that in Example 1 except that sodium carbonate was used instead of the phosphoric acid. Note that the content of sodium carbonate was 2% by mass relative to 100% by mass of carbon material precursor.

### Example 18

A carbon material precursor was obtained in the same manner as that in Example 1 except that sodium hydrogen carbonate was used instead of the phosphoric acid. Note that the content of sodium hydrogen carbonate was 2% by mass relative to 100% by mass of carbon material precursor.

### Example 19

A carbon material precursor was obtained in the same manner as that in Example 1 except that oxalic acid was used instead of the phosphoric acid. Note that the content of oxalic acid was 2% by mass relative to 100% by mass of carbon material precursor.

### Example 20

A carbon material precursor was obtained in the same manner as that in Example 1 except that citric acid was used instead of the phosphoric acid. Note that the content of citric acid was 2% by mass relative to 100% by mass of carbon material precursor.

### Example 21

A carbon material precursor was obtained in the same manner as that in Example 1 except that the content of phosphoric acid in the carbon material precursor was changed to 0.5% by mass.

### Example 22

A carbon material precursor was obtained in the same manner as that in Example 1 except that the content of phosphoric acid in the carbon material precursor was changed to 5% by mass.

### Example 23

A carbon material precursor was obtained in the same manner as that in Example 1 except that the content of phosphoric acid in the carbon material precursor was changed to 10% by mass.

### Example 24

A carbon material precursor was obtained in the same manner as that in Example 2 except that the content of diammonium hydrogen phosphate in the carbon material precursor was changed to 0.5% by mass.

### Example 25

A carbon material precursor was obtained in the same manner as that in Example 2 except that the content of diammonium hydrogen phosphate in the carbon material precursor was changed to 5% by mass.

### Example 26

A carbon material precursor was obtained in the same manner as that in Example 2 except that the content of diammonium hydrogen phosphate in the carbon material precursor was changed to 10% by mass.

### Comparative Example 1

A carbon material precursor was obtained in the same manner as that in Example 1 except that no addition component was added.

### <Measurement of Carbonization Yield>

A differential thermal balance (“TG8120” manufactured by Rigaku Corporation) was used to heat 3.2 to 3.5 mg of each of the carbon material precursors obtained in Examples and Comparative Example from room temperature to 500° C. at a rate of temperature rise of 10° C./min under a nitrogen stream having a flow rate of 200 ml/min. In consideration of the influence of water adsorbed to polyacrylamide, the mass of the carbon material precursor at 150° C. was taken as a reference to calculate the carbonization yield of each carbon material precursor by use of the following formula:

Carbonization Yield[%]=M₅₀₀/M₁₅₀×100

[M₅₀₀: Mass of Carbon Material Precursor at 500° C., M₁₅₀: Mass of Carbon Material Precursor 150° C.]Table 1 indicates the addition components and the carbonization yields of the carbon material precursors obtained in Examples 1 to 20 and Comparative Example 1. Also, FIG. 1 illustrates the relationship between the carbonization yields and the contents of the addition components in the carbon material precursors obtained in Examples 1 and 2, Examples 21 to 26, and Comparative Example 1.

TABLE 1

| Addition Component | Carbonization Yield [%] |
|---|---|
| Phosphoric Acid | 41.2 |
| Diammonium Hydrogen Phosphate | 40.3 |
| Ammonium Dihydrogen Phosphate | 41.4 |
| Polyphosphoric Acid | 42.1 |
| Trisodium Phosphate | 19.1 |
| Sodium Hydrogen Phosphate | 17.2 |
| Sodium Dihydrogen Phosphate | 25.9 |
| Tripotassium Phosphate | 19.9 |
| Dipotassium Hydrogen Phosphate | 19.1 |
| Potassium Dihydrogen Phosphate | 26.7 |
| Boric Acid | 30.1 |
| Ammonium Sulfate | 26.1 |
| Ammonium Hydrogen Sulfate | 27.5 |
| Sodium Sulfate | 17.8 |
| Sodium Hydrogen Sulfate | 26.4 |
| Sodium Nitrate | 22.7 |
| Sodium Carbonate | 21.7 |
| Sodium Hydrogen Carbonate | 18.9 |
| Oxalic Acid | 18.1 |
| Citric Acid | 19.6 |
| No Additive | 15.1 |

As is apparent from the results shown in Table 1, the carbonization yield of the carbon material precursor was improved by blending at least one addition component selected from the group consisting of acids and salts thereof into the acrylamide-based polymer.

Also, as is apparent from the results shown in FIG. 1, the carbonization yield of the carbon material precursor was improved by increasing the content of at least one addition component selected from the group consisting of acids and salts thereof.

### Production Example 1

A thermally-stabilized carbon material precursor was obtained by heating (thermally-stabilizing) the carbon material precursor obtained in Example 1 in the air at 250° C. for 30 minutes. Carbon material was obtained by heating (carbonizing) this thermally-stabilized carbon material precursor under a nitrogen gas atmosphere at 1000° C. for 10 minutes.

As described above, the present invention makes it possible to obtain a carbon material precursor which contains an acrylamide-based polymer and has a high carbonization yield.

Thus, the method for producing carbon material of the present invention is useful as a method capable of safely producing carbon material at a low cost because a carbon material precursor which is dissolved in an aqueous solvent and exhibits a high carbonization yield is used.

1. A carbon material precursor comprising:
an acrylamide-based polymer; and
at least one addition component selected from the group consisting of acids and salts thereof.

2. The carbon material precursor according to claim 1, wherein
the addition component is at least one selected from the group consisting of phosphoric acid, polyphosphoric acid, boric acid, sulfuric acid, nitric acid, carbonic acid, oxalic acid, citric acid, sulfonic acid, and salts thereof.

3. The carbon material precursor according to claim 1, wherein
the addition component is at least one selected from the group consisting of ammonium salts and amine salts.

4. The carbon material precursor according to claim 1, wherein
the addition component is the salt of the acid, wherein
the acid is at least one selected from the group consisting of phosphoric acid, polyphosphoric acid, boric acid, sulfuric acid, nitric acid, carbonic acid, oxalic acid, citric acid, and sulfonic acid; and
the salt is least one selected from the group consisting of ammonium salts and amine salts.

5. The carbon material precursor according to claim 1, wherein
a content of the addition component is 0.1 to 20% by mass relative to 100% by mass of the carbon material precursor.

6. A method for producing a carbon material comprising:
thermally-stabilizing the carbon material precursor according to claim 1; and
then carbonizing the carbon material precursor.

7. The method for producing a carbon material according to claim 6, wherein in the thermal-stabilization, the carbon material precursor is heated under an oxidizing atmosphere at a temperature of 500° C. or lower.

8. The method for producing a carbon material according to claim 7, wherein in the carbonization, the thermally-stabilized carbon material precursor is heated under an inert atmosphere at a temperature higher than the heating temperature during the thermal-stabilization.
